(19) United States
(12) Patent Application Publication
(10) Pub. No.: US 2002/0095599 A1
(43) Pub. Date: Jul. 18, 2002

(54) VoIP call control proxy

(76) Inventors: Hyungkeun Hong, Santa Clara, CA (US); Wongyu Cho, San Jose, CA (US)

Correspondence Address: Ronald S. Henderson, Esq., Barnes & Thornburg, 11 South Meridian Street, Indianapolis,, IN, 46204, US

(21) Appl. No.: 09/760,347

(22) Filed: Jan. 12, 2001

(51) Int. Cl. H04L 9/00

(52) U.S. Cl. 713/201

(57) ABSTRACT

A method and associated system for exchanging data with computers within a secure network. The present invention includes a first computer, which transmits data to a second computer. The second computer receives the data and transmits them to a third computer, which is within a secure network. The data is transmitted to the third computer over a connection originated from within the secure network, which allows the data to pass through network security devices, such as firewalls.

### BACKGROUND OF THE INVENTION

1. Field of the Invention

This invention generally relates to computer networks and more particularly to methods and associated systems for exchanging electronic content with computers within a secure network.

2. Related Art

Voice Over Internet Protocol (VoIP) is a technique for transmitting electronic content, such as control messages and voice signals using the Internet Protocol (IP). In VoIP, electronic content from an audio communications device (e.g., a telephone or a computer equipped with audio peripherals) is sent over a network such as the Internet.

The transmission of electronic content to a computer within a secure network presents a problem because, in most situations, a firewall or similar device keeps incoming electronic content from entering the secure network.

### SUMMARY

The present invention relates to a method and associated system for exchanging electronic content with computers within a secure network. The present invention includes a first computer, which transmits data to a second computer. The second computer receives the data and transmits them to a third computer, which is within a secure network. The data is transmitted to the third computer over a connection originated from within the secure network, which allows the data to pass through network security devices, such as firewalls.

In one embodiment, a method is provided for transmitting electronic content including establishing a first communication connection to a first computer within a secure network; receiving a communication request initiated by a second computer outside the secure network; establishing a second communication connection to the second computer; and transmitting a control message between the first computer using the first communication connection and the second computer using the second communication connection.

In another embodiment, a system is provided for transmitting data to a computer inside a secure network. The system includes a first computer inside the secure network, which has established a communication with a second computer outside the secure network. The system also includes a third computer outside the secure network and communicating with the second computer, such that data is transmitted from the first computer to the third computer through the second computer.

In yet another embodiment, a method is provided for establishing a communication session including establishing a communication connection between a first computer within a secure network and a proxy; providing a second computer outside of the secure network an address to the proxy; transmitting electronic content between the first computer and the proxy; and transmitting the electronic content between the proxy and the second computer.

In yet another embodiment, a method is provided including registering status information from a first computer inside a secure network; establishing a first communication connection between a proxy and the first computer; transmitting the status information to a second computer; establishing a second communication connection between the second computer and the proxy; and transmitting electronic content from the second computer to the proxy and from the proxy to the first computer.

These and other features of the invention will be apparent to persons of ordinary skill in the art upon reading the following description and figures.

### BRIEF DESCRIPTION OF THE DRAWINGS

FIG. 1A shows a schematic diagram of a typical network;

FIG. 1B shows a schematic diagram of a typical network including a firewall;

FIG. 2 shows a schematic diagram of a network in accordance with an embodiment of the invention;

FIG. 3 shows a method for transmitting data to a computer within a secure network in one embodiment;

FIG. 4 shows a method for transmitting data to a computer within a secure network in another embodiment;

FIG. 5 shows a flow diagram of a VoIP telephone call in one embodiment;

FIG. 6 shows a schematic diagram of a network in accordance with another embodiment of the invention;

FIG. 7 shows a method for establishing a communication connection with a computer within a secure network in one embodiment;

FIG. 8 shows a method for transmitting data to a computer within a secure network in another embodiment; and

FIG. 9 shows a flow diagram of a communication in one embodiment.

The use of the same reference symbol in different figures indicates the same or identical elements.

### DETAILED DESCRIPTION

The detailed description that follows is presented largely in terms of processes and symbolic representations of operations performed by conventional computers. The computer executes an appropriate operating system such as Linux, Unix, Microsoft® Windows® 95, Microsoft® Windows® 98, Microsoft® Windows® NT, Apple® MacOS®, IBM® OS/2®, and the like. The computer may advantageously be equipped with a network communication device such as a network interface card, a modem, or other network connection device suitable for connecting to one or more networks.

The computer, and the computer memory, may advantageously contain program logic or other substrate configuration representing data and instructions, which cause the computer to operate in a specific and predefined manner as, described herein. The program logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like.

The program logic conventionally includes the manipulation of data bits by the processor and the maintenance of these bits within data strictures resident in one or more of the memory storage devices. Such data structures impose a physical organization upon the collection of data bits stored within computer memory and represent specific electrical or magnetic elements. These symbolic representations are the means used by those of ordinary skill in the art to effectively convey teachings and discoveries to others of ordinary skill in the art.

The program logic is generally considered to be a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those of ordinary skill in the art to refer to these signals as bits, values, elements, symbols, characters, text, terms, numbers, records, files, or the like. It should be noted that these and some other terms should be associated with appropriate physical quantities for computer operations, and that these terms are merely conventional labels applied to physical quantities that exist within and during operation of the computer.

It should be understood that manipulations within the computer are often referred to in terms of adding, comparing, retrieving, playing, moving, searching, and the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general purpose computing machines or devices may be used with programs constructed in accordance with the teachings described herein. Similarly, it may prove advantageous to construct a specialized apparatus to perform the method steps described herein by way of dedicated computer systems with hard-wired logic or programs stored in non-volatile memory, such as read-only memory (ROM).

Generally, a communication system for Internet telephony is provided to allow a caller, using an Internet telephone service, to place a telephone call to an audio communications device, such as a telephone, a PC, or a Personal Data Assistant (PDA). The communication system can be used with any Internet telephone service, such as those provided by Dialpad.com™, Phonefree.com™, Net2phone™, and similar Internet telephone services. A type of Internet telephone service is disclosed and described in co-pending and commonly assigned U.S. patent application Ser. No. 09/401,898, entitled “Scaleable Communications System,” filed Sep. 24, 1999, which is incorporated herein by reference in its entirety.

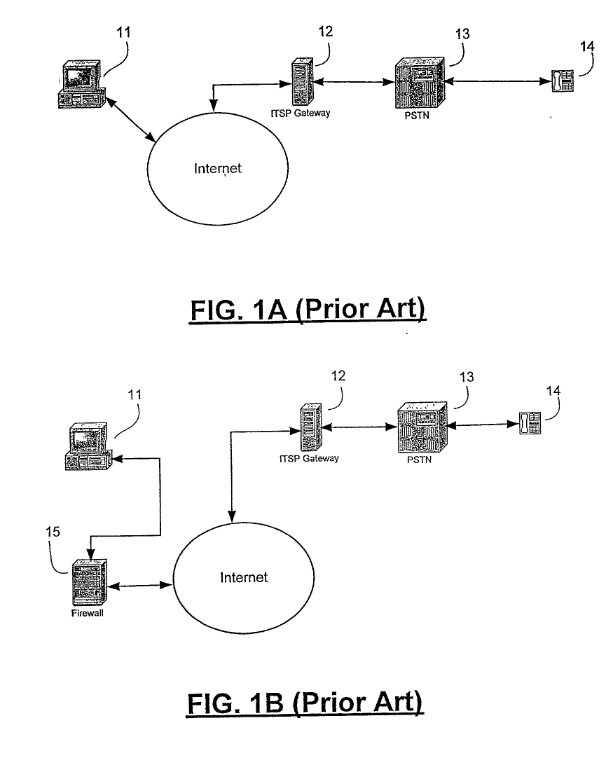

FIG. 1A shows a schematic diagram of an exemplary VoIP network. A local user using a computer 11 equipped with a sound card and headset, for example, provides voice data to an Internet Telephone Service Provider (ITSP) gateway 12 over the Internet. ITSP gateways are available from several network service providers including the IDT Corporation and Qwest Communications. ITSP gateway 12 is coupled to a remote user who, in this example, uses a regular telephone 14 linked to a public switched telephone network (PSTN) 13. PSTN 13 provides either wireline or wireless telephone service commonly known as “plain old telephone service” (POTS). ITSP gateway 12 converts the voice data from computer 11 into corresponding voice signals for transmission to telephone 14 through PSTN 13. Conversely, ITSP gateway 12 converts voice signals received from telephone 14 into a form that is suitable for transmission over the Internet to computer 11.

FIG. 1B schematically illustrates a network where computer 11 is located behind a firewall 15. Firewalls are well known network components for screening incoming data to a secure network. Data that use a connection created by computers behind firewall 15 are able to pass through firewall 15. A connection is a communications link between two application programs (e.g., programs running on separate computers) on a network. The connection is identified by the IP addresses and port numbers of the two connected application programs. The IP address identifies the computer on which an application program runs while the port number identifies the application program in the computer. If computer 11 creates a connection through firewall 15 to ITSP gateway 12, ITSP gateway 12 can send data to computer 11 using the same connection (unless of course firewall 15 is specifically configured to block any data from ITSP gateway 12). However, computers outside firewall 15 cannot arbitrarily create a connection through firewall 15. Thus, unless ITSP gateway 12 uses a connection originated from behind firewall 15, voice signals from telephone 14 will not reach computer 11.

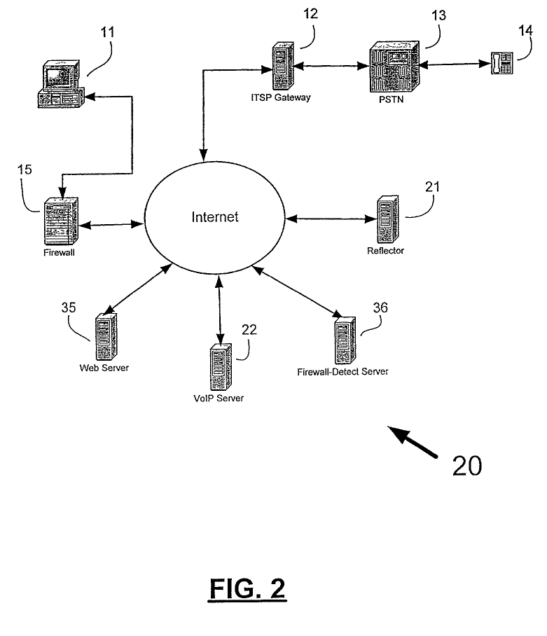

FIG. 2 shows a schematic diagram of a network 20 wherein a reflector 21 application program, running on a computer acting as a server, is used to allow data transmission through firewall 15. While reflector 21 can be resident on any computer in network 20 that is outside firewall 15, reflector 21 is preferably on a separate high performance computer located close to ITSP gateway 12 to minimize data transmission delay and possible data loss. Network 20 includes a VoIP server 22 for setting up a VoIP telephone call between the user on computer 11 and the user on telephone 14. Reflector 21 can be employed independent of VoIP server 22, and can be generally used to exchange data with computers behind firewalls.

Referring to FIG. 2, client program for making the VoIP telephone call and files containing information about network 20 can be downloaded from a web server 35 (e.g., a website). Web server 35 can be a conventional file server or any of the VoIP portals accessible over the Internet such as those from Dialpad.com, Inc. of Santa Clara, Calif. Network 20 also includes a firewall-detect server 36 which, as discussed further below, enables a client program running on computer 11 to detect whether it is behind a firewall. It is to be noted that client-server architectures, in general, are well known.

VoIP server 22, ITSP gateway 12, web server 35, and the client program running on computer 11 can also be of the same type as the scaleable communications system disclosed in U.S. patent application Ser. No. 09/401,898, previously incorporated herein. Reflector 21 can also be used with VoIP systems and services accessible over the Internet such as those from Dialpad.Com, Inc.

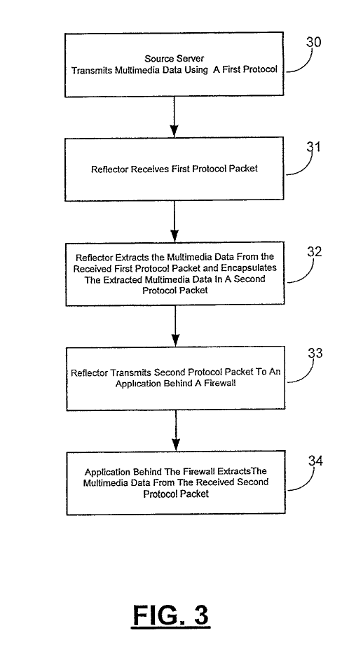

FIG. 3 shows a method for transmitting data to a computer within a secure network in one embodiment. In action 30, multimedia data (e.g., voice, video, still images, and/or fax) from a source server such as ITSP gateway 12 are transmitted to reflector 21 in accordance with a first protocol. Reflector 21 receives the first protocol packets from the source server (action 31), extracts the multimedia data from the first protocol packets, and encapsulates the multimedia data in accordance with a second protocol (action 32). In one example, the multimedia data are formatted in accordance with RTP and the first protocol is UDP. Reflector 21 transmits the second protocol packets to an application (e.g., client program) behind the firewall (action 33), where the multimedia data are extracted (action 34). In one example, the second protocol is the Transmission Control Protocol (TCP). TCP, a connection-oriented protocol, transports data using a pre-established connection between two application programs. Thus, reflector 21 can transmit data to an application program behind the firewall by using a TCP connection originated from within the secure network.

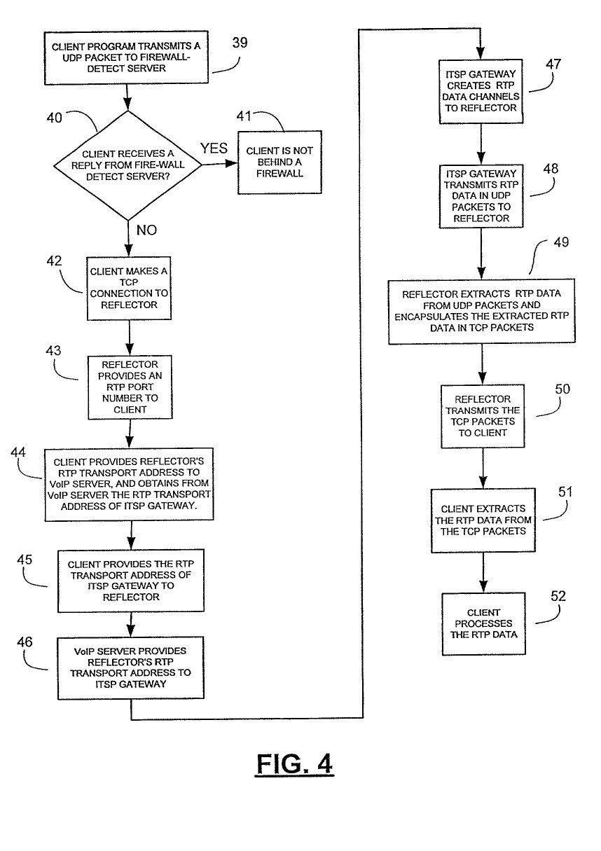

FIG. 4 shows a method for transmitting voice data from ITSP gateway 12 to computer 11 of network 20 (FIG. 2) in one embodiment. In action 39, a client program running on computer 11 transmits a UDP packet to firewall-detect server 36 located outside firewall 15. Firewall-detect server 36 is a server that waits for a UDP packet from the client program and correspondingly replies with another UDP packet. The UDP packets transmitted to and from firewall-detect server 36 are intended to determine whether the client program runs on a computer behind a firewall. In action 40, the client program waits for a reply from firewall-detect server 36. If the client program receives a reply from firewall-detect server 36, the client program is not behind a firewall and reflector 21 is therefore not required (action 41). In this example, however, the client program is behind firewall 15, which blocks the reply from firewall-detect server 36. After failing to receive a reply from firewall-detect server 36 within a predetermined amount of time, the client program concludes that it must be behind a firewall and accordingly creates a conventional TCP connection to reflector 21 (action 42). Any protocol suitable for transmission through a firewall, such as those that use a pre-established connection, can be used instead of TCP. The IP address of reflector 21 can be hard-coded in the client program or downloaded from web server 35.

In action 43, reflector 21 provides an RTP port number to the client program. This RTP port number along with reflector 21's IP address, as explained below, will eventually be provided to ITSP gateway 12 so that RTP data can be transmitted from ITSP gateway 12 to reflector 21. Hereinafter, the IP address and RTP port number of reflector 21 for receiving RTP data from ITSP gateway 12 are collectively referred to as reflector 21's RTP transport address. In action 44, the client program provides reflector 21's RTP transport address to VoIP server 22, and obtains from VoIP server 22 the transport address of ITSP gateway 12. The transport address of ITSP gateway 12 consists of the IP address and RTP port number that ITSP gateway uses to receive RTP data from reflector 21.

In action 45, the client program provides reflector 21 the RTP transport address of ITSP gateway 12. This allows reflector 21 to transmit the RTP data it receives from the client program to ITSP gateway 12.

In action 46, VoIP server 22 provides the RTP transport address of reflector 21 to ITSP gateway 12. Action 46 typically occurs during the time the VoIP telephone call between computer 11 and telephone 14 is being setup by VoIP server 22 and ITSP gateway 12 in accordance with the International Telecommunication Union (ITU) H.323 standard and associated protocols. ITU H.323 is well known; e.g., see ITU-T Recommendation Q.931, ITU-T Recommendation H.245, and ITU-T Recommendation H.323, all incorporated herein by reference.

In action 47, ITSP gateway 12 creates RTP data channels to and from reflector 21 in accordance with ITU H.323. Note that both ITSP gateway 12 and reflector 21 know each other's RTP transport address and can thus exchange RTP data over the RTP data channels. ITSP gateway 12 formats the voice signals from telephone 14 in accordance with RTP (hereinafter “RTP data”), encapsulates the RTP data in UDP packets, and transmits the UDP packets over the RTP data channel from ITSP gateway 12 to reflector 21 (action 48). The flow of RTP data between ITSP gateway 12 and reflector 21 over the RTP data channels is also known as an RTP data stream.

In action 49, reflector 21 extracts the RTP data from the UDP packets received from ITSP gateway 12. The RTP data are then encapsulated in TCP packets before being transmitted to the client program on computer 11.

In action 50, reflector 21 transmits the TCP packets containing RTP data to the client program in computer 11 over the TCP connection previously established in action 42. Because that TCP connection was created by the client program, which is in the secure network, reflector 21 is able to transmit the TCP packets through firewall 15.

In action 51, the client program extracts the RTP data from the TCP packets. Thereafter, the client program processes the RTP data by playing the corresponding voice information from telephone 14 (action 52).

The transmission of RTP data from computer 11 to telephone 14 is performed using a process similar to that shown in FIG. 4 except in the opposite direction. In one example, the client program formats the voice of the local user in accordance with RTP and encapsulates the resulting RTP data in TCP packets, which are then transmitted to reflector 21 using the TCP connection previously established in action 42.

The TCP packet is transmitted from the client program in computer 11 to reflector 21. Reflector 21 extracts the RTP data from the received TCP packets and encapsulates the RTP data in UDP packets for transmission over the RTP data channel from reflector 21 to ITSP gateway 12. ITSP gateway 12 then extracts the RTP data from the UDP packets and relays the voice information to telephone 14.

Voice data from computer 11 can also be directly transmitted to ITSP gateway 12 because computer 11 is behind firewall 15, and thus can create another connection through firewall 15 onto ITSP gateway 12. In one example, the client program formats the user's voice in accordance with RTP and encapsulates the resulting RTP data in UDP packets. The client program directly transmits the UDP packets to ITSP gateway 12 without going through reflector 21. ITSP gateway 12 extracts the RTP data from the UDP packets and relays the voice information to telephone 14.

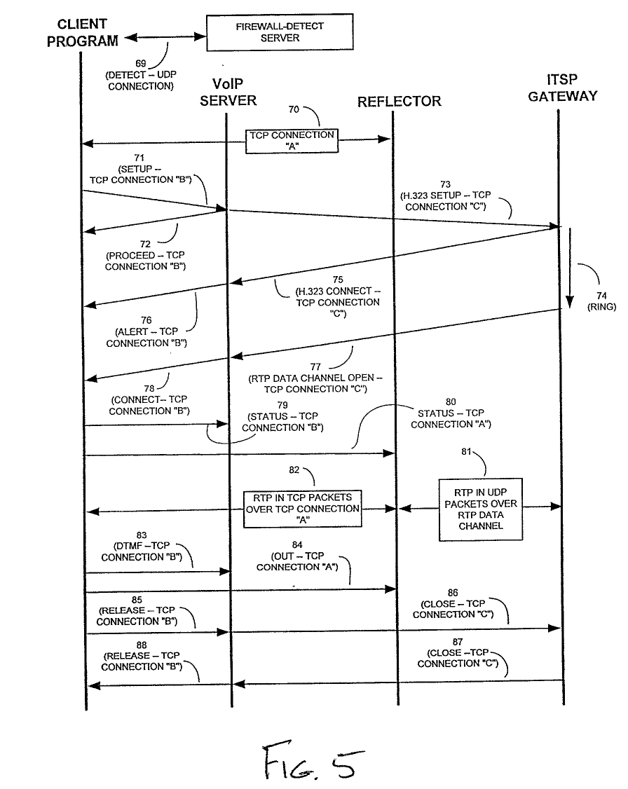

FIG. 5 shows a flow diagram of an exemplary VoIP telephone call between computer 11 and telephone 14 in network 20 (FIG. 2). In flow 69, the client program on computer 11 transmits a UDP packet to firewall-detect server 36 to determine if computer 11 is behind a firewall. All communications between the client program and firewall-detect server 36 are over an arbitrary UDP connection. Because computer 11 is behind firewall 15 in this example, the client program will not receive a response from firewall-detect server 36. In flow 70, the client program thus makes a TCP connection, hereinafter referred to as TCP connection “A”. to reflector 21. All communications between the client program and reflector 21 are over TCP connection “A”. Also during flow 70, reflector 21 provides its RTP transport address to the client program.

In flow 71, the client program makes a separate TCP connection, hereinafter referred to as TCP connection “B”, to VoIP server 22 and informs VoIP server 22 that it wants to make a VoIP telephone call to telephone 14. All communications between the client program and VoIP server 22 are over TCP connection “B”. In flow 71, the client program also provides reflector 21's RTP transport address to VoIP server 22. In flow 72, VoIP server 22 informs the client program that the VoIP telephone call is proceeding.

In flow 73, VoIP server 22 setups the VoIP telephone call with ITSP gateway 12 in accordance with the ITU H.323 standard. All communications between VoIP server 22 and ITSP gateway 12 are over a separate TCP connection hereinafter referred to as TCP connection “C”. In flow 74, ITSP gateway 12 makes a call to telephone 14 via PSTN 13 (FIG. 2) and receives a ring signal. In flow 75, ITSP gateway 12 informs VoIP server 22 that telephone 14 has been contacted. VoIP server 22 receives the RTP transport address of ITSP gateway 12 at this time. In flow 76, VoIP server 22 relays the information to the client program, which now knows that the telephone 14 is ringing and can be picked-up by the remote user at any time. Also in flow 76, the client program receives the RTP transport address of ITSP gateway 12 from VoIP server 22.

In flow 77, ITSP gateway 12 informs VoIP server 22 that telephone 14 has been picked-up by the remote user and that it will start transmitting RTP data to reflector 21 (using reflector 21's RTP transport address) over an RTP data channel. There are two RTP data channels in this example, which are an RTP data channel from ITSP gateway 12 to reflector 21 and another RTP data channel from reflector 21 to ITSP gateway 12. In flow 78, VoIP server 22 informs the client program that telephone 14 has been picked up and that the client program can now send and receive RTP data via reflector 21.

In flow 79, the client program reports its status (including error conditions and whether it is still making the VoIP telephone call) to VoIP server 22. Flow 79 is periodically performed while the VoIP telephone call is in progress. In one example, VoIP server 22 will terminate an in progress VoIP telephone call if VoIP server 22 ceases to receive a status from the client program.

In flow 80, the client program informs reflector 21 that the remote user has picked-up telephone 14 and that reflector 21 should expect to receive RTP data over the RTP data channel from ITSP gateway 12. Also in flow 80, reflector 21 receives the RTP transport address of ITSP gateway 12 from the client program. This allows reflector 21 to send RTP data over the RTP data channel to ITSP gateway 12.

In flow 81, RTP data representing voice information are transported between reflector 21 and ITSP gateway 12 using UDP packets over the RTP data channels. In flow 82, the RTP data are transported between reflector 21 and the client program using TCP packets over TCP connection “A”.

In flow 83, DTMF touch tone signals, if any, are transmitted from the client program to VoIP server 22. The DTMF touch tone signals are then relayed by VoIP server 22 to ITSP gateway 12 over TCP connection “C” (not shown).

In flow 84, the client program informs reflector 21 that the user on computer 11 decides to terminate the VoIP telephone call. In flow 85, the client program also informs VoIP server 22 that the VoIP telephone call is being terminated. In flow 86, VoIP server 22 accordingly informs ITSP gateway 12 to close the RTP data channels between ITSP gateway 12 and reflector 21. In flow 87, ITSP gateway 12 informs VoIP server 22 that the RTP data channels have been closed. In flow 88, VoIP server 22 informs the client program that the VoIP telephone call has been terminated.

One of ordinary skill in the art will appreciate that the sequence of events in the flow diagram of FIG. 5 can be re-arranged without detracting from the merits of the invention. For example, the RTP transport address of ITSP gateway 12 can be provided to reflector 21 at any time before flow 82, and not necessarily during flow 80 when the client program provides its status to reflector 21.

In one embodiment, reflector 21 is written in the “C” programming language and runs on a SPARC™ Station computer with the Solaris™ operating system. both of which are available from Sun Microsystems. Of course, other programming languages, computers, and operating systems can also be used.

A type of Internet telephone service using a reflector is disclosed and described in co-pending and commonly assigned U.S. patent application Ser. No. 09/627,723, entitled “Data Exchange with Computers Within A Secure Network,” filed Jul. 28, 2000, which is incorporated herein by reference in its entirety.

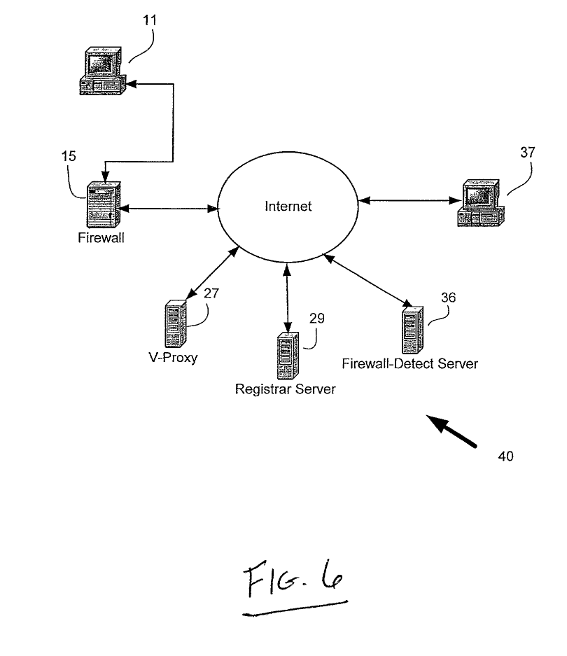

FIG. 6 is a schematic diagram of another embodiment in accordance with the present invention, which allows a caller using a computer outside of a secure network to establish a communication and exchange electronic content with a recipient computer within a secure network (i.e. behind a firewall). This embodiment includes a network 40 including a proxy application program, running on a computer acting as a proxy server 27, used to allow data transmission through firewall 15. While proxy server 27 can be resident on any computer in network 40 that is outside firewall 15, proxy server 27 is preferably on a separate high performance computer. Network 40 includes a registration application program, running on a computer acting as a registrar server 29, used for allowing a recipient client to register status information, as described in greater detail below. While registrar server 29 can be resident on any computer in network 40 that is outside firewall 15, registrar server 29 is preferably on a separate high performance computer. Optionally, network 40 can include a firewall-detect server 36, as discussed further below, which enables a client program running on computer 11 to detect whether it is behind a firewall. It is to be noted that client-server architectures, in general, are well known.

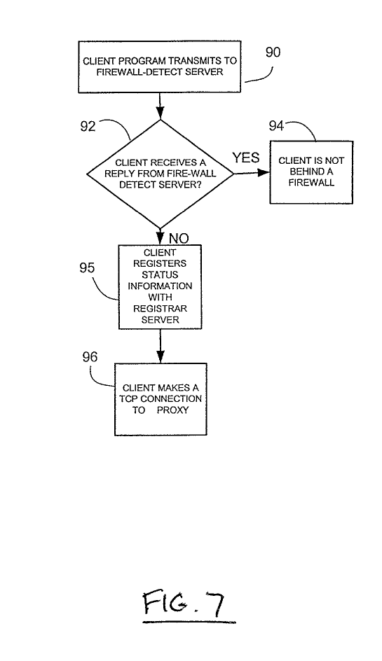

In one embodiment, FIG. 7 illustrates a flow diagram of a method for enabling electronic content, such as a call control message to come from a caller's computer 37 through firewall 15 to a recipient's computer 11 of network 40 (FIG. 6). In action 90, a client program running on recipient's computer 11 transmits, for example, a UDP packet to firewall-detect server 36 located outside firewall 15. Firewall-detect server 36 waits for a UDP packet from the client program and correspondingly replies with another UDP packet. The UDP packets transmitted to and from firewall-detect server 36 are intended to determine whether the client program runs on a computer behind a firewall. In action 92, the client program waits for a reply from firewall-detect server 36. If the client program receives a reply from firewall-detect server 36, the client program is not behind a firewall and proxy server 27 is therefore not required (action 94).

In this example, however, the client program is behind firewall 15, which blocks the reply from firewall-detect server 36. After failing to receive a reply from firewall-detect server 36 within a predetermined amount of time, the client program concludes that it must be behind a firewall. It should be noted that the above example for detecting the existence of firewall 15 is merely illustrative and not intended to be limiting.

In one embodiment, since recipient's computer 11 is behind firewall 15, the client provides an alternate means for a caller program on caller's computer 37 to create a communication connection with the client program on recipient's computer 11. In action 95, the client program provides status information to registrar server 29, which indicates. for example, whether or not recipient's computer 11 is “on-line” at the present time and whether or not it is behind firewall 15. The client program can also provide an alternate transport address to registrar server 29, since a communication connection can not be directly established using the IP address and port number (hereinafter, the IP address and port number are collectively referred to as the transport address) associated with the client program on recipient's computer 11 behind firewall 15. For example, the client program can provide the transport address of proxy 27, in addition to a corresponding unique ID. As described below, the corresponding unique ID can be used to identify and correlate the transport address of proxy 27 with a preestablished connection to the client program on recipient's computer 11.

Once the client program provides the status information to registrar server 29, the recipient's computer 11 is deemed registered. In general, registrar server 29 provides the status information provided to registrar server 29 by the client program to any outside caller who wishes to establish a communication connection (i.e. a call request) with a registered recipient.

In action 96, after registering with registrar server 29, computer 11 creates a conventional TCP connection to proxy server 27. Recipient's computer 11 provides proxy server 27 the unique ID, which corresponds to the TCP connection to recipient's computer 11. Proxy server 27 stores the TCP connection and unique ID until a call request arrives at proxy server 27.

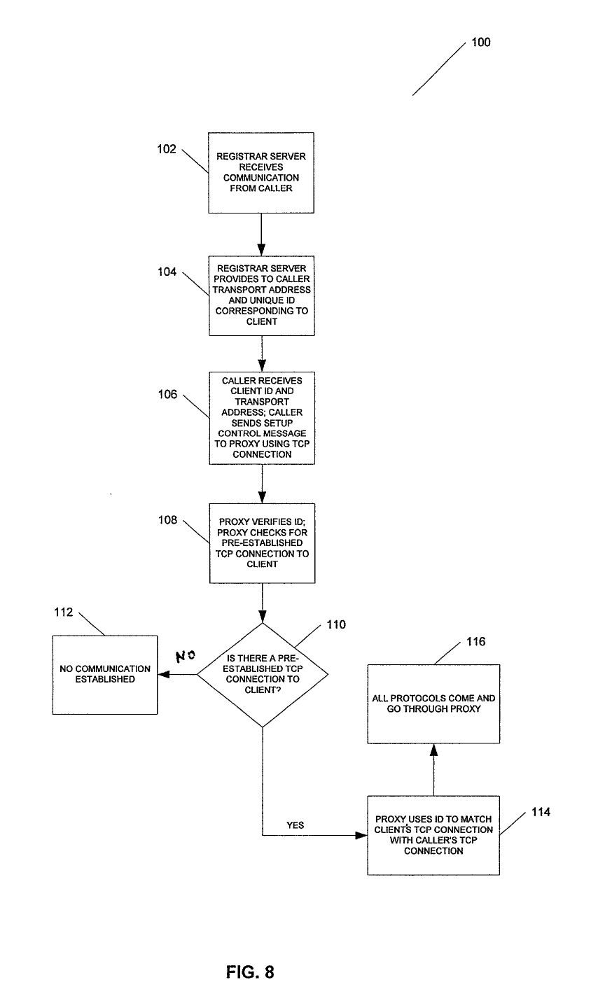

FIG. 8 is a flow chart illustrating a process 100 for allowing electronic content, such as a call control message to be sent between a caller program on caller's computer 37 and the client program on recipient's computer 11, which is behind firewall 15 (FIG. 6). In action 102 of process 100, registrar server 29 (FIG. 6) receives an indication that the caller program on caller's computer 37 is attempting to establish a communication connection with the client program on recipient's computer 11.

In action 104, once registrar server 29 receives the indication, registrar server 29 provides the caller program on caller's computer 37 the client's status information, such as whether or not the recipient is on-line, whether or not the client is behind a firewall, the client's transport address (e.g., the transport address of proxy 27) and the unique ID.

In action 106. the caller program on caller's computer 37 receives the client's status information. Using the transport address of proxy 27, the caller program on caller's computer 37 initiates a call using a TCP connection to proxy 27. The caller program delivers the call setup control message and the unique ID to proxy 27.

In action 108, proxy server 27 verifies that the unique ID corresponds to the client's pre-established TCP connection established in action 96 (FIG. 7). In action 110, if the caller program on recipient's computer 11 has no established connection to proxy server 27, which corresponds to the unique ID, the communication is not established (action 112). In this example, the client program on recipient's computer 11 has previously established a connection (action 96, FIG. 7). Accordingly, in action 114, proxy server 27 uses the unique ID contained in the call set up control message to establish a communication with caller's pre-established TCP connection. The call set up control message from the caller program on caller's computer 37 is relayed to the client program on recipient's computer 11 over the pre-established TCP connection.

In action 116, all protocols between the caller program on caller's computer 37 and the client program on recipient's computer 11 are relayed through proxy server 27.

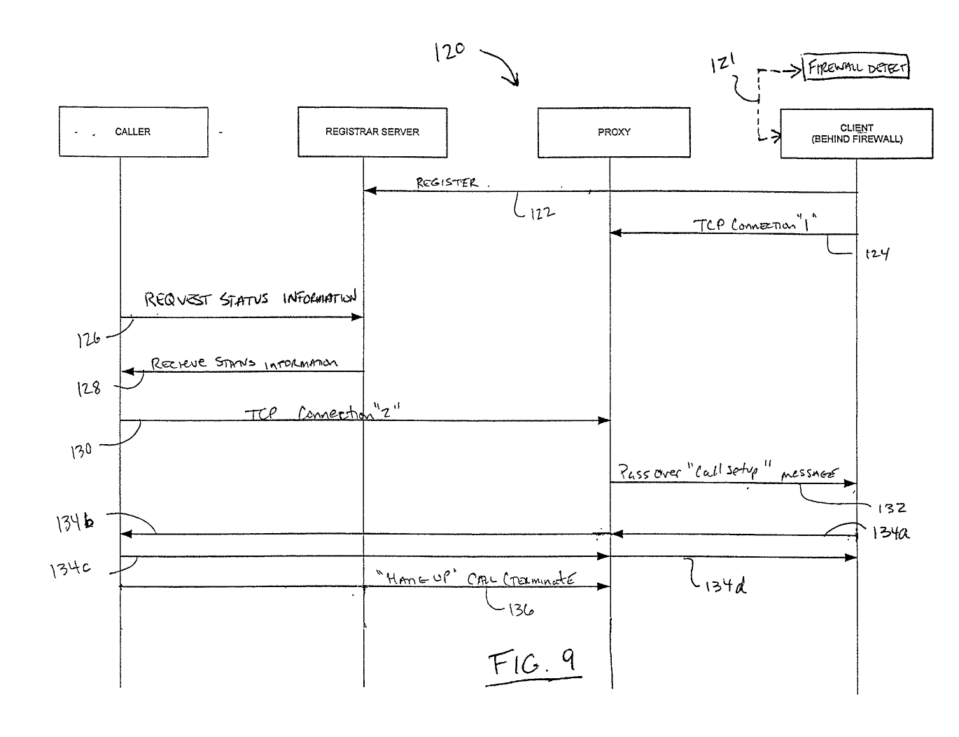

FIG. 9 shows a flow diagram of an exemplary embodiment of a communication 120 between a client program on client's computer 11 and a caller program on caller's computer 37 in network 40 (FIG. 6). With reference now to FIG. 6 and FIG. 9, as an initial action 121, the client program on client's computer 11 transmits a UDP packet to firewall-detect server 36 to determine if client's computer 11 is behind firewall 5. All communications between the client program and firewall-detect server 36 can be over an arbitrary UDP connection. Because clients' computer 11 is behind firewall 15 in this example, the client program will not receive a response from firewall-detect server 36.

In flow 122, the client program registers status information, which is information that enables registrar server 29 to receive a call request from the caller program outside of firewall 15. For example, the registration information can include, but is not limited to, whether or not the client's computer is behind firewall 15, whether or not the client is on-line at the present time, the transport address of proxy 27, and the unique ID.

After registering, in flow 124, the client program on client's computer 11 establishes a TCP connection (hereinafter referred to as TCP connection “1”) to proxy server 27. All communications between the client program on client's computer 11 and proxy server 27 are over TCP connection “1”.

In flow 126, the caller program on caller's computer 37 informs registrar server 29 that the caller program on caller's computer 37 intends to initiate a communication connection to the client program on client's computer 11. Registrar server 29 verifies that the client program is behind a firewall. Once verified, registrar server 29 verifies that the client program has established TCP connection “1” to proxy server 27. If no connection was made, no communication between the caller program and the client program is established. If TCP connection “1” has been established, in flow 128, registrar server 29 transmits the client's status information, such as the transport address of proxy 27 and the unique ID that corresponds to TCP connection “1” to the caller program on caller's computer 11.

In flow 130, a TCP connection (hereinafter referred to as TCP connection “2”) is established between the caller program on caller's computer 37 and proxy server 27. All communications between the caller program on caller's computer 37 and proxy server 27 are over TCP connection “2”. The caller program on caller's computer 37 sends a Call Setup Control message to proxy server 27 using TCP connection “2”, which can include, for example, a transport address for caller's computer 37, and the client's unique ID. Proxy server 27 verifies that the unique ID corresponds to the client's TCP connection “1”.

If a match is found, in flow 132, the call set up control message is “passed over” or relayed from proxy 27 to the client program on client's computer 11. The call set up control message informs the client program that the caller program is making an attempt to establish a communication connection and that the client program on the client's computer 37 should expect to receive further data over TCP connection “1” established in flow 124.

In flow 134a, a responsive call set up control message and other data, for example, are transmitted between client's computer 11 and proxy server 27 over TCP connection “1”. In flow 134b, the responsive call set up control message and other data can then be transmitted between proxy server 27 and the caller program on caller's computer 37 over TCP connection “2”.

In flow 134c, a relevant call set up control message and other data can be transmitted between the caller program on caller's computer 37 and proxy server 27 over TCP connection “2”. In flow 134d, the call set up control message and other data can be transmitted between proxy server 27 and the client program on client's computer 11 over TCP connection “1”.

In flow 136, the caller program informs proxy server 27 that the user on computer 37 decides to terminate the communication.

One of ordinary skill in the art will appreciate that the sequence of events in the flow diagram of FIG. 9 can be re-arranged without detracting from the merits of the invention.

While specific embodiments of this invention have been described, it is to be understood that these embodiments are illustrative and not limiting. Many additional embodiments that are within the broad principles of this invention will be apparent to persons skilled in the art. Further, the invention is applicable to any type of network, including those not linked to the Internet.

What is claimed is:

1. A method for transmitting data comprising:
establishing a first communication connection to a first computer within a secure network;
receiving a communication request initiated by a second computer outside said secure network;
establishing a second communication connection to said second computer; and
transmitting a control message between said first computer using said first communication connection and said second computer using said second communication connection.

2. The method of claim 1, wherein a firewall separates said first computer from said second computer.

3. The method of claim 1, wherein said first and said second communication connections comprise a Transmission Control Protocol (TCP).

4. The method of claim 1, wherein said second computer comprises a personal computer using Transmission Control Protocol (TCP).

5. A system for transmitting data to a computer inside a secure network comprising:
a first computer outside said secure network;
a second computer outside said secure network and communicating with said first computer; and
a third computer inside said secure network and communicating with said first computer where electronic content can be transmitted from said second computer to said third computer through said first computer.

6. The system of claim 5, further comprising a firewall coupled between said third computer and said second computer.

7. The system of claim 5, further comprising a fourth computer for receiving a registration package from said third computer inside said secure network.

8. The system of claim 7, wherein said registration package comprises transport data and a unique ID.

9. The system of claim 5, wherein said first computer and said third computer comprise a personal computer (PC).

10. The system of claim 5, wherein said second computer comprise a computer capable of initiating a communication.

11. The system of claim 5, wherein said first computer comprises a proxy computer for relaying electronic content between said second and said third computers.

12. A method for establishing a communication session comprising:
establishing a communication connection between a first computer within a secure network and a proxy;
providing a second computer outside of said secure network an address to said proxy;
transmitting electronic content between said first computer and said proxy; and
transmitting said electronic content between said proxy and said second computer.

13. The method of claim 12, wherein said electronic content comprises a call set up control message.

14. The method of claim 12, wherein a firewall separates said first computer from said proxy.

15. The method of claim 12, wherein said communication connection comprises a Transmission Control Protocol (TCP).

16. The method of claim 12, further comprising registering status information between said first computer and a register server.

17. A method comprising:
registering status information from a first computer inside a secure network;
establishing a first communication connection between a proxy and said first computer;
transmitting said status information to a second computer;
establishing a second communication connection between said second computer and said proxy; and
transmitting electronic content from said second computer to said proxy and from said proxy to said first computer.

18. The method of claim 17, wherein said status information comprises a transport address.

19. The method of claim 17, wherein said electronic content comprises a call set up control message.

20. The method of claim 17, further comprising transmitting electronic content from said first computer to said proxy and from said proxy to said second computer.
